(19) United States
(12) Patent Application Publication
(10) Pub. No.: US 2010/0067144 A1
(43) Pub. Date: Mar. 18, 2010

(54) Magnetic recording medium, magnetic recording and reproducing apparatus, and method for manufacturing magnetic recording medium

(75) Inventor: Katsumichi Tagami, Saku-shi (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 12/585,386

(22) Filed: Sep. 14, 2009

(30) Foreign Application Priority Data
Sep. 18, 2008 (JP) 2008-239987

(51) Int. Cl. G11B 5/127; G11B 5/33

(52) U.S. Cl. 360/110; 428/800; G9B/5.04

(57) ABSTRACT

The magnetic recording medium includes: a substrate; a recording layer formed in a predetermined concavo-convex pattern over the substrate, the recording layer including recording elements formed as convex portions of the concavo-convex pattern; a filling material disposed in a concave portion between the recording elements; and a lubricant disposed over the recording element and the filling material. The filling material and the lubricant are fluorine-based organic compounds, and the mass average molecular weight of the filling material is greater than the mass average molecular weight of the lubricant.

### BACKGROUND OF THE INVENTION

1. Field of the Invention

The present invention relates to a magnetic recording medium including a recording layer formed in a concavo-convex pattern, to a magnetic recording and reproducing apparatus including the same, and to a method for manufacturing the magnetic recording medium.

2. Description of the Related Art

Conventionally, in magnetic recording and reproducing apparatus such as hard disks, a lubricant is applied to the surface of a magnetic recording medium to prevent the breakage of the magnetic recording medium due to the contact with a magnetic head. A significant improvement in the areal density of such magnetic recording and reproducing apparatus has been achieved by, for example, reducing the size of magnetic particles constituting a recording layer of magnetic recording media, changing materials, and improving the precision of magnetic head processing. A further improvement in the areal density is expected in the future. However, problems due to limitations with respect to magnetic head processing technology and the broadening of the recording magnetic field from a magnetic head have become apparent, resulting in issues such as incorrect recording of information on a track adjacent to a target recording track and crosstalk during reproduction. The improvement of the areal density by conventional improvement techniques has therefore reached its limit.

Hence, discrete track media and patterned media have been proposed as candidates for magnetic recording media in which a further improvement in the areal density can be achieved. In the discrete track media and patterned media, a recording layer is formed in a concavo-convex pattern, and recording elements are formed as convex portions of the concavo-convex pattern. The recording elements of discrete track media have a shape corresponding to the shape of the tracks, and the recording elements of patterned media have a shape formed by circumferentially dividing the tracks.

In magnetic recording and reproducing apparatus such as hard disks, the flatness of the surface of a magnetic recording medium is an important factor to stabilize the flying height of the magnetic head so that good recording and reproducing characteristics are achieved. Therefore, in one preferred approach, a filling material is deposited over the recording layer formed in a concavo-convex pattern to fill the concave portions between the recording elements, and the excess portion of the filling material above the recording layer is removed to flatten the upper surfaces of the recording elements and the filling material (see, for example, Japanese Patent Application Laid-Open No. Hei 9-97419). A non-magnetic chemically stable oxide, for example, may be used as the filling material. A sputtering method, for example, may be used as a technique for depositing the filling material to fill the concave portions. CMP (Chemical Mechanical Polishing) or dry etching may be used as a technique for removing the excess portion of the filling material to flatten the surface. It is believed to be preferable that a lubricant is applied to a magnetic recording medium after the upper surfaces of the recording elements and the filling material are flattened. Moreover, it is believed that it is preferable to use a lubricant having a small molecular weight and capable of easily restoring its shape because the form of the lubricant on the surface of the magnetic recording medium may be deformed due to intermittent contact of the magnetic recording medium with a magnetic head.

However, the method for flattening the surface by depositing a filling material such as an oxide to fill the concave portions and removing the excess portion of the filling material possesses a problem that the manufacturing cost is high since equipment for processing such as sputtering, CMP, and dry etching is required. Another problem of the method is that the time for processing such as sputtering, CMP, and dry etching is long.

In one known method for addressing these problems, a lubricant is deposited to fill the concave portions between recording elements without filling the concave portions with a filling material such as an oxide (see, for example, Japanese Patent Application Laid-Open No. 2000-293843).

However, since such a lubricant is flowable, the lubricant disposed in the concave portions may flow onto the recording elements as the magnetic recording medium is rotated at a high speed for a long period of time. In other words, a lubricant having a small molecular weight has an advantage in that its shape is easily restored, whereas such a lubricant disadvantageously tends to flow from the concave portions onto the recording elements with ease. Therefore, the thickness of the lubricant over the recording elements sometimes increases excessively, so that, disadvantageously, the magnetic head is likely to adhere to the magnetic recording medium. Another problem is that the step heights between convex portions and concave portions in the surface of the magnetic recording medium increase, so that the flying height of the magnetic head becomes unstable.

### SUMMARY OF THE INVENTION

In view of the foregoing problems, various exemplary embodiments of this invention provide a magnetic recording medium including a recording layer formed in a concavo-convex pattern, having good recording and reproducing characteristics, and excellent in productivity, a magnetic recording and reproducing apparatus including such a magnetic recording medium and a method for manufacturing the magnetic recording medium.

The above object is achieved by a magnetic recording medium, comprising: a substrate; a recording layer formed in a predetermined concavo-convex pattern over the substrate, the recording layer including recording elements formed as convex portions of the concavo-convex pattern; a filling material disposed in a concave portion between the recording elements; and a lubricant disposed over the recording element and the filling material, wherein the filling material and the lubricant are fluorine-based organic compounds, and wherein a mass average molecular weight of the filling material is greater than amass average molecular weight of the lubricant.

Moreover, the above object is achieved by a method for manufacturing a magnetic recording medium, comprising: a filling material applying step of applying a filling material onto a workpiece having a surface formed in a predetermined concavo-convex pattern to thereby dispose the filling material in a concave portion of the concavo-convex pattern; and a lubricant applying step of applying a lubricant onto the filling material, wherein the filling material and the lubricant are fluorine-based organic compounds, and wherein a mass average molecular weight of the filling material is greater than a mass average molecular weight of the lubricant.

The filling material as well as the lubricant is fluorine-based organic compound. Thus, the filling material can be easily disposed in the concave portions of the concavo-convex pattern by applying the filling, material to the workpiece having the concavo-convex pattern formed thereon. Moreover, the excess portion of the filling material can be easily removed by, for example, washing with a solvent. Therefore, the productivity of the above magnetic recording medium is high.

Though the filling material as well as the lubricant of the magnetic recording medium is flowable fluorine-based organic compound, the mass average molecular weight of the filling material is greater than that of the lubricant. Thus, the flowability of the filling material is less than that of the lubricant. Therefore, even when the magnetic recording medium is rotated at a high-speed for a long period of time, the filling material disposed in the concave portions is less likely to flow onto the recording elements.

Even if the filling material disposed in the concave portions flows onto the recording elements, the filling material does not flow onto the recording elements to the extent that the magnetic head is likely to adhere to the magnetic recording medium and the flying height of the magnetic head is unstable because the flowability of the filling material is lower than that of the lubricant. Note that, in the course of arriving at the present invention, the inventor has prepared various magnetic recording media with various step heights between convex portions and concave portions in the surface and has measured the flying height of the magnetic head. Consequently, the inventor has found that, even when the concave portions between the recording elements are not fully filled with the filling material and convex and concave portions exist in the surface of the magnetic recording medium, the flying height of the magnetic head can be stabilized. More specifically, when the step heights between convex portions and concave portions in the surface are about 1 to 10 nm, the flying height can be stabilized as in the case of a nearly flat surface.

Since the lubricant having a mass average molecular weight less than that of the filling material and capable of easily restoring its shape is disposed over the recording elements and the filling materials, the lubrication properties of the surface of the magnetic recording medium is good.

Even when the filling material disposed in the concave portions flows onto the recording elements, the lubrication performance of the surface of the magnetic recording medium can be maintained in a good condition because the filling material as well as the lubricant is fluorine-based organic compound that can serve as a lubricant over the recording elements.

Accordingly, various exemplary embodiments of this invention provide a magnetic recording medium, comprising: a substrate; a recording layer formed in a predetermined concavo-convex pattern over the substrate, the recording layer including recording elements formed as convex portions of the concavo-convex pattern; a filling material disposed in a concave portion between the recording elements; and a lubricant disposed over the recording element and the filling material, wherein the filling material and the lubricant are fluorine-based organic compounds, and wherein a mass average molecular weight of the filling material is greater than a mass average molecular weight of the lubricant.

Moreover, various exemplary embodiments of this invention provide a method for manufacturing a magnetic recording medium, comprising: a filling material applying step of applying a filling material onto a workpiece having a surface formed in a predetermined concavo-convex pattern to thereby dispose the filling material in a concave portion of the concavo-convex pattern; and a lubricant applying step of applying a lubricant onto the filling material, wherein the filling material and the lubricant are fluorine-based organic compounds, and wherein a mass average molecular weight of the filling material is greater than a mass average molecular weight of the lubricant.

In this application, the phrase “a recording layer formed in a predetermined concavo-convex pattern, the recording layer including recording elements formed as convex portions of the concavo-convex pattern” is used to refer to a recording layer formed by dividing a continuous recording layer in a predetermined pattern such that the convex portions of the pattern serving as the recording elements are completely separated from each other. In addition, the above phrase is also used to include: a recording layer including convex portions that are separated from each other in data areas but are continuous near the boundaries between the data areas and servo areas; a recording layer formed continuously on a part of a substrate (for example, a recording, layer having a spiral shape); a recording layer formed separately on upper surfaces of convex portions and on bottom surfaces of concave portions of a concavo-convex pattern of a layer below the recording layer, wherein the portions formed on the upper surfaces of the convex portions serve as the recording elements; a recording layer in which concave portions are formed to a certain depth in the thickness direction such that the recording layer is continuous at bottom portions of the concave portions; and a continuous recording layer deposited in a concavo-convex pattern following concavo-convex pattern of a layer below the recording layer.

In this application, the phrase “a thickness of the filling material is greater in the concave portions between the recording elements than over the recording elements” is used to include: the case in which the filling material is disposed in the concave portions between the recording elements and over the recording elements and the thickness of the filling material disposed in the concave portions is greater than the thickness of the filling material disposed over the recording elements; and the case in which the filling material is disposed only in the concave portions between the recording elements and not disposed over the recording elements.

In this application, the phrase “a lowest point of an upper surface of the filling material disposed in the concave portion is lower than an upper surface of the protection film on the recording element” is used to mean that a point of the upper surface of the filling material, the point being closest to the substrate, is closer to the substrate than the upper surface of the protection film on the recording elements.

In this application, the term “DLC” is used to refer to a material including carbon as a main component and having carbon bonds involving SP³ hybrid orbitals. The phrase “a material including carbon as a main component” is used to refer to a material containing carbon in an atomic ratio of 50% or more based on the total number of atoms constituting the material.

In the present application, the term “magnetic recording medium” is not limited to media, such as hard disks, FLOPPY® disks, and magnetic tapes, in which magnetism alone is used to record and reproduce information. The term is also used to include magneto-optical recording media, such as MO (magneto-optical) disks, and heat-assisted recording media in which magnetism is used together with light or heat.

### BRIEF DESCRIPTION OF THE DRAWINGS

FIG. 1 is a perspective view schematically illustrating a general structure of a magnetic recording and reproducing apparatus according to a first exemplary embodiment of the present invention;

FIG. 2 is a cross-sectional view in a radial direction, schematically illustrating the structure of a magnetic recording medium of the magnetic recording and reproducing apparatus;

FIG. 3 is an enlarged cross-sectional view in the radial direction, illustrating around a filling material and a lubricant of the magnetic recording medium;

FIG. 4 is a flowchart showing an outline of manufacturing process of the magnetic recording medium;

FIG. 5 is a cross-sectional view in the radial direction, schematically illustrating the structure of a starting workpiece used in the manufacturing process;

FIG. 6 is a cross-sectional view in the radial direction, schematically illustrating the shape of the workpiece on which a resin layer is formed in a concavo-convex pattern;

FIG. 7 is a cross-sectional view in the radial direction, schematically illustrating the shape of the workpiece in which a recording layer is processed in a concavo-convex pattern;

FIG. 8 is a cross-sectional view in the radial direction, schematically illustrating the shape of the workpiece having a filling material applied to the recording layer to fill concave portions thereof;

FIG. 9 is a cross-sectional view in the radial direction, schematically illustrating the shape of the workpiece with an excess portion of the filling material removed;

FIG. 10 is a cross-sectional view in the radial direction, schematically illustrating the structure of a magnetic recording medium according to a second exemplary embodiment of the invention;

FIG. 11 is an enlarged cross-sectional view in the radial direction, illustrating around the filling material and the lubricant of the magnetic recording medium;

FIG. 12 is a flowchart showing an outline manufacturing process of the magnetic recording medium;

FIG. 13 is a cross-sectional view in the radial direction, schematically illustrating the shape of a workpiece having a protection film deposited in the manufacturing process of the magnetic recording medium so as to conform to the surface of a concavo-convex pattern;

FIG. 14 is an enlarged cross-sectional view in the radial direction, schematically illustrating around filling materials and the lubricant of a magnetic recording medium according to a third exemplary embodiment of the invention;

FIG. 15 is an enlarged cross-sectional view in the radial direction, schematically illustrating around the filling materials and the lubricant of a magnetic recording medium according to a fourth exemplary embodiment of the invention;

FIG. 16 is an enlarged cross-sectional view in the radial direction, schematically illustrating around the filling material and the lubricant of a magnetic recording medium according to a fifth exemplary embodiment of the invention;

FIG. 17 is an enlarged cross-sectional view in the radial direction, schematically illustrating around the filling material and the lubricant of a magnetic recording medium according to a sixth exemplary embodiment of the invention; and

FIG. 18 is an enlarged cross-sectional view in the radial direction, schematically illustrating around the lubricant of a magnetic recording medium of Comparative Example.

### DETAILED DESCRIPTION OF THE PREFERRED EMBODIMENTS

Hereinafter, preferred exemplary embodiments of the present invention will be described in detail with reference to the drawings.

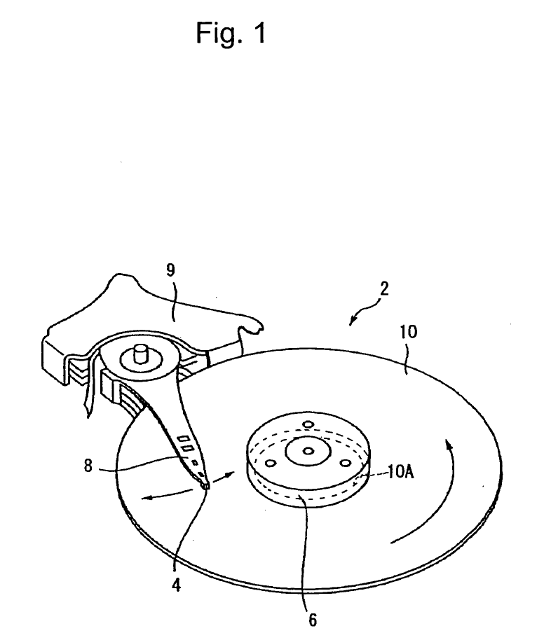

As shown in FIG. 1, a magnetic recording and reproducing apparatus 2 according to a first exemplary embodiment of the present invention includes a magnetic recording medium 10 and a magnetic head 4 that is disposed so as to be capable of flying in close proximity to the surface of the magnetic recording medium 10 in order to record and reproduce magnetic signals thereon and therefrom.

The magnetic recording medium 10 has a center hole 10A and is connected at the center hole 10A to a spindle motor (not shown) through a chuck 6. The magnetic recording medium 10 is rotatable together with the chuck 6. The magnetic head 4 is attached near the end of an arm 8, and the arm 8 is rotatably attached to a base 9. Therefore, the magnetic head 4 can move in an arc-shaped trajectory along the radial direction of the magnetic recording medium 10 while located in close proximity to the surface of the magnetic recording medium 10.

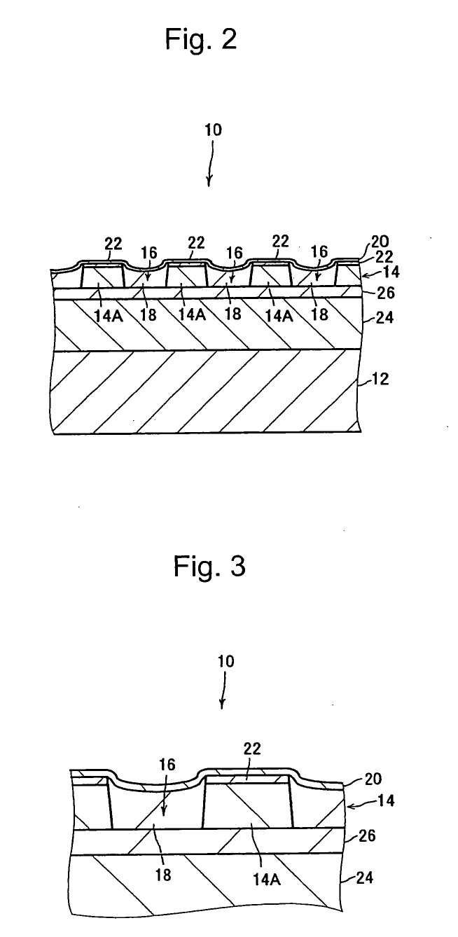

The magnetic recording medium 10 is a discrete track medium of a perpendicular recording type. As shown in FIGS. 2 and 3, the magnetic recording medium 10 includes: a substrate 12; a recording layer 14 formed in a predetermined concavo-convex pattern over the substrate 12, the recording layer 14 including recording elements 14A formed as convex portions of the concavo-convex pattern; a filling material 18 disposed in concave portions 16 between the recording elements 14A; and a lubricant 20 disposed over the recording elements 14A and the filling material 18. The magnetic recording medium 10 is characterized in that the filling material 18 and the lubricant 20 are fluorine-based organic compounds and that the mass average molecular weight of the filling material 18 is greater than that of the lubricant 20. The description of the configuration of other components is omitted as appropriate because it does not seem to be important for understanding of the first exemplary embodiment.

The magnetic recording medium 10 further includes a protection film 22 disposed on the recording elements 14A. The lubricant 20 over the recording elements 14A is disposed in contact with the upper surface of the protection film 22. The lubricant 20 over the concave portions 16 between the recording elements 14A is disposed in contact with the filling material 18.

The magnetic recording medium 10 further includes a soft magnetic layer 24 and a seed layer 26. The soft magnetic layer 24, the seed layer 26, the recording layer 14, the protection film 22, and the lubricant 20 are disposed over the substrate 12 in that order.

The substrate 12 has a substantially disk-like shape with a center hole. Glass, Al, Si, Al₂O₃, or the like may be used as the material for the substrate 12.

The recording layer 14 has a thickness of 5 to 30 nm. A CoPt-based alloy such as a CoCrPt alloy, an FePt-based alloy, a laminate thereof, a composite material composed of a matrix of an oxide material, such as SiO₂, and ferromagnetic particles, such as CoCrPt particles, contained in the matrix, or the like may be used as the material for the recording layer 14. In data areas, the recording elements 14A, which are the convex portions of the recording layer 14, are formed to have a track shape, i.e., in concentric arc shapes radially spaced at small intervals. FIGS. 2 and 3 are radial cross-sectional views showing this structure. In the data areas, the radial width of the upper surfaces of the recording elements 14A is 10 to 100 nm. The radial width of the concave portions 16 is 10 to 100 at the level of the upper surfaces of the recording elements 14A. The magnetic recording medium 10 has servo areas radially arranged at appropriate circumferential intervals. The servo areas and the data areas are alternately arranged in the circumferential direction. In the servo areas, the recording elements 14A are formed in a predetermined servo pattern (not shown).

The filling material 18 and the lubricant 20 are fluorine-based organic compounds, as described above. Examples of such a fluorine-based organic compound include a fluorinated ether, a fluorinated alcohol, a fluorinated carboxylic acid, and a fluorinated carboxylic acid ester (fluorinated carboxylic acid alkyl ester). For example, a fluorine-based organic compound having a chain structure such as (C₂F₄O)ₘ(CF₂O)ₙ, (CF₂O)ₘ, (C₂F₃O)ₘ, (C₂F₄O)ₘ, (CF₂F₆O)ₘ, (C₂F₆O)ₘ, (CF₂O)ₘ(CF₂F₃O)ₙ, or (C₃F₆O)ₘ(CF₂O)ₙ may be used. More specifically, a fluorine-based organic compound having a chain structure such as —(—CF₂—CF₂—O—)ₘ(—CF₂—O—)ₙ—, —(—CF₂—O—)ₘ—, —(—CF—CF₂—O—)ₘ—, —(—CF₂—CF₂—O—)ₘ—, —(—CF₂—CF₂—CF₂—O—)ₘ—, —(—CF (CF₃)—CF₂—O—)ₘ—, —(—CF₂—O—)ₘ(—CF—CF₂—O—)ₙ—, or —(—CF(CF₃)—CF₂—O—)ₘ(—CF₂—O—)ₙ— may be used. Here, m and n are real numbers of 1 or more. For example, a fluorine-based organic compound represented by any of the following formulas (I) to (VIII) may be used:

X—CF₂—O(—CF₂—CF₂—O—)ₘ(—CF₂—O—)ₙCF₂—Z, (I)

X—CF₂—O(—CF₂—O—)ₘCF₂—Z, (II)

X—CF₂—O(—CF—CF₂—O—)ₘCF₂—Z, (III)

X—CF₂—O(—CF₂—CF₂—O—)ₘCF₂—Z, (IV)

X—CF₂—O(—CF₂—CF₂—CF₂—O—)ₘCF₂—Z, (V)

X—CF₂—O(—CF(CF₃)—CF₂—O—)ₘCF₂—Z, (VI)

X—CF₂—O(—CF₂—O—)ₘ(—CF—CF₂—O—)ₙCF₂—Z, and (VII)

X—CF₂—O(—CF(CF₃)—CF₂—O—)ₘ(—CF₂—O—)ₙCF₂—Z. (VIII)

Here, X and Z are each a functional group such as —CF₃, —CH₂—OH, —CH₂(—O—CH₂—CH₂—)ₚ—OH, or —CH₂—O—CH₂—CH(OH)—CH₂—OH, but not limited thereto. For example, each of X and Z may, be a functional group represented by any of the following general formulas [Chemical formula 1] and [Chemical formula 2]:

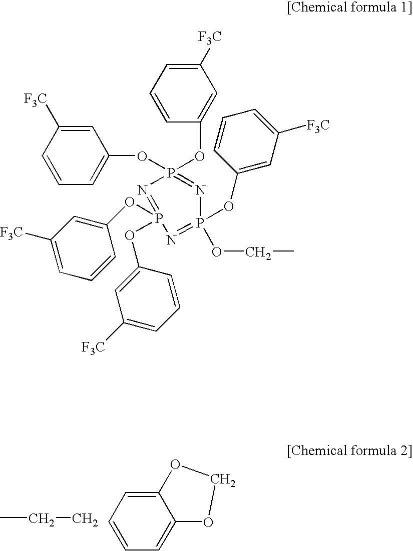

Preferably, each of the compounds has at least one functional group having an OH group. P is an integer of 1 or more. The functional group X at one end of each of the formulas (I) to (VIII) and the functional group Z at the other end may be the same or different. A fluorine-based organic compound having a structure represented by one of the formulas (I) to (VIII), having only one of the functional groups X and Z at one end, and having no functional group at the other end may be used.

The greater the centrifugal force acting on the lubricant and on the filling material 18 is, the more likely the lubricant 20 and the filling material 18 are to flow. The greater the outer diameter of the magnetic recording medium 10 is, the greater the centrifugal force acting on the lubricant 20 and the filling material 18 is. Moreover, the greater the rotation speed of the magnetic recording medium 10, the greater the centrifugal force acting on the lubricant 20 and the filling material 18. Therefore, to suppress the flow of the lubricant 20 and the filling material 18, it is preferable to use a lubricant 20 and a filling material 18 having larger mass average molecular weights as the outer diameter of the magnetic recording medium 10 is greater. Moreover, as the rotation speed of the magnetic recording medium 10 is higher, it is preferable to use a lubricant 20 and a filling material 18 having larger mass average molecular weights. However, to improve the lubrication properties, it is preferable to use a lubricant 20 and a filling material 18 having small mass average molecular weights. Accordingly, it is preferable to select a combination of a lubricant 20 and a filling material having appropriate mass average molecular weights, respectively, according to the outer diameter and rotation speed of the magnetic recording medium 10.

For example, when a filling material 18 having a mass average molecular weight of 2,100 to 10,000 is used, it is preferable to use a lubricant 20 having a mass average molecular weight of 1,000 to 2,000.

For example, when a filling material 18 having a mass average molecular weight of 2,500 to 10,000 is used, it is preferable to use a lubricant 20 having a mass average molecular weight of 1,000 to 2,400, and it is more preferable to use a lubricant 20 having a mass average molecular weight of 2,000 to 2,400.

For example, when a filling material 18 having a mass average molecular weight of 3,500 to 10,000 is used, it is preferable to use a lubricant 20 having a mass average molecular weight of 1,000 to 3,400, and it is more preferable to use a lubricant 20 having a mass average molecular weight of 2,400 to 3,400.

Specific examples of the combination of the filling material 18 and the lubricant 20 are listed in Table 1 below.

TABLE 1

| | Lubricant | Filling material |
|---|---|---|
| Chemical formula | Formula (I) | Formula (I) |
| | m ≈ 10 n ≈ 10 | m ≈ 10.3 n ≈ 10.3 |
| | X: —CH₂—OH | X: —CH₂—O—CH₂—CH(OH)—CH₂—OH |
| | Z: —CH₂—OH | Z: —CH₂—O—CH₂—CH(OH)—CH₂—OH |
| Mass average | 2000 | 2165 |
| molecular weight | | |
| Chemical formula | Formula (I) | Formula (I) |
| | m ≈ 10 n ≈ 10 | m ≈ 15.4 n ≈ 15.4 |
| | X: —CH₂—OH | X: [Chemical formula 2] |
| | Z: —CH₂—OH | Z: [Chemical formula 2] |
| Mass average | 2000 | 3200 |
| molecular weight | | |
| Chemical formula | Formula (I) | Formula (I) |
| | m ≈ 5.6 n ≈ 5.6 | m ≈ 3.7 n ≈ 3.7 |
| | X: [Chemical formula 1] | X: [Chemical formula 1] |
| | Z: —CH₂—OH | Z: [Chemical formula 1] |
| Mass average | 2144 | 2740 |
| molecular weight | | |
| Chemical formula | Formula (I) | Formula (I) |
| | m ≈ 3.7 n ≈ 3.7 | m ≈ 36.9 n ≈ 36.9 |
| | X: [Chemical formula 1] | X: [Chemical formula 1] |
| | Z: [Chemical formula 1] | Z: [Chemical formula 1] |
| Mass average | 2740 | 8794 |
| molecular weight | | |

Specific examples of a commercial product of the lubricant in the first and second rows of Table 1 include Fomblin-Z-Dol-2000 (Solvay Solexis). Specific examples of a commercial product of the filling material in the first row of Table 1 include Fomblin-Z-TETRAOL-20005 (Solvay Solexis). Specific examples of a commercial product of the filling material in the second row of Table 1 include Fomblin AM 3001 (Solvay Solexis). Specific examples of a commercial product of the lubricant in the third row of Table 1 include MORESCO Phosfarol A20H (Matsumura Oil Research Corp.). Specific examples of a commercial product of the filling material in the third row of Table 1 include MORESCO Phosfarol A20H-D (Matsumura Oil Research Corp.). Note that Fomblin and MORESCO are Registered Trade Marks.

The filling material 18 has a thickness of 3 to 25 nm. Preferably, the thickness of the filling material 18 disposed in the concave portions 16 between the recording elements 14A is greater than the thickness of the lubricant 20 disposed on the filling material 18. In the first exemplary embodiment, the filling material 18 is disposed only in the concave portions 16 between the recording elements 14A and not disposed over the recording elements 14A. Therefore, the thickness of the filling material 18 is greater in the concave portions 16 between the recording elements 14A than over the recording elements 14A. Preferably, the lowest point of the upper surface of the filling material 18 disposed in the concave portions 16 between the recording elements 14A is lower than the upper surface of the protection film 22 on the recording elements 14A. In other words, it is preferable that the lowest point of the upper surface of the filling material 18 disposed in the concave portions 16 between the recording elements 14A is lower than the lower surface of the lubricant 20 over the recording elements 14A.

The thickness of the lubricant 20 is 1 to 3 nm. In FIGS. 2 and 3, the lubricant 20 is disposed over the entire surface of the magnetic recording medium 10 so as to fully cover the filling material 18 and the protection film 22. However, areas on which the lubricant 20 is not disposed and on which the filling material 18 and/or the protection film 22 appear may be scattered on the surface of the magnetic recording medium 10. In this case, the lubricant 20 can preferably cover 40% or more, and more preferably 50% or more, of the surface of the magnetic recording medium 10.

The protection film 22 has a thickness of 1 to 5 nm. DLC (diamond like carbon) may be used as the material for the protection film 22.

The soft magnetic layer 24 has a thickness of 20 to 200 nm. An Fe alloy, a Co alloy, or a material having a synthetic structure composed of the above materials may be used as the material for the soft magnetic layer 24.

The seed layer 26 has a thickness of 2 to 40 nm. A nonmagnetic material such as a CoCr alloy, Ti, Ru, a laminate of Ru and Ta, or MgO may be used as the material for the seed layer 26.

Next, a description will be given of the operation of the magnetic recording and reproducing apparatus 2.

In the magnetic recording and reproducing apparatus 2, since the filling material 18 is disposed in the concave portions 16 between the recording elements 14A of the magnetic recording medium 10, the step height between convex portions and concave portions in the surface of the magnetic recording medium 10 is less than those of the recording layer 14. Therefore, the flying height of the magnetic head 4 is stable, so that good recording and reproducing characteristics are obtained. As described above, even when the convex portions and concave portions are formed in the surface of the magnetic recording medium 10, the flying height of the magnetic head 4 is stable, as in the case where the surface is substantially flat, if the step height between convex portions and concave portions in the surface is 10 nm or less. To stabilize the flying height of the magnetic head 4, it is more preferable that the step height between convex portions and concave portions in the surface of the magnetic recording medium 10 be 5 nm or less.

The filling material 18 of the magnetic recording medium 10 as well as the lubricant 20 is a flowable fluorine-based organic compound. However, since the mass average molecular weight of the filling material 18 is greater than that of the lubricant 20, the flowability of the filling material 18 is lower than that of the lubricant 20. Therefore, even when the magnetic recording medium 10 is rotated at a fast speed for a long period of time, the filling material 18 disposed in the concave portions 16 is less likely to flow onto the recording elements 14A.

The lowest point of the upper surface of the filling material 18 disposed in the concave portions 16 between the recording elements 14A is lower than the upper surface of the protection film 22 on the recording elements 14A. Also in this respect, the filling material 18 disposed in the concave portions 16 is less likely to flow onto the recording elements 14A.

As described above, the flowability of the filling material 18 is lower than that of the lubricant 20. Therefore, even if the filling material 18 disposed in the concave portions 16 flows onto the recording elements 14A, the filling material 18 does not flow onto the recording elements 14A to the extent that the magnetic head 4 is likely to adhere to the magnetic recording medium 10 or the flying height of the magnetic head 4 is unstable.

The lubricant 20 has a mass average molecular weight lower than that of the filling material 18 and more easily restores its shape than the filling material 18. Since such a lubricant 20 is disposed over the recording elements 14A and the filling material 18, the surface of the magnetic recording medium 10 has good lubrication properties.

As described above, the thickness of the filling material 18 disposed in the concave portions 16 between the recording elements 14A is greater than the thickness of the lubricant 20 disposed over the filling material 18. With this configuration, when the thickness of the easily flowable lubricant 20 disposed in the concave portions 16 is reduced accordingly, the step height between convex portions and concave portions in the surface of the magnetic recording medium 10 can be reduced. Since the thickness of the easily flowable lubricant 20 disposed in the concave portions 16 can be reduced as described above, the flow of the lubricant 20 disposed in the concave portions 16 onto the recording elements 14A can be suppressed.

The filling material 18 as well as the lubricant 20 is a fluorine-based organic compound and can serve as a lubricant over the recording elements 14A. Therefore, even if the filling material 18 disposed in the concave portions 16 flows onto the recording elements 14A, the lubrication properties of the surface of the magnetic recording medium 10 can be maintained in a good condition.

Since the filling material 18 is disposed only in the concave portions 16 between the recording elements 14A and not disposed over the recording elements 14A, the magnetic gap between the recording elements 14A and the magnetic head 4 is small, so that good recording and reproducing characteristics are obtained.

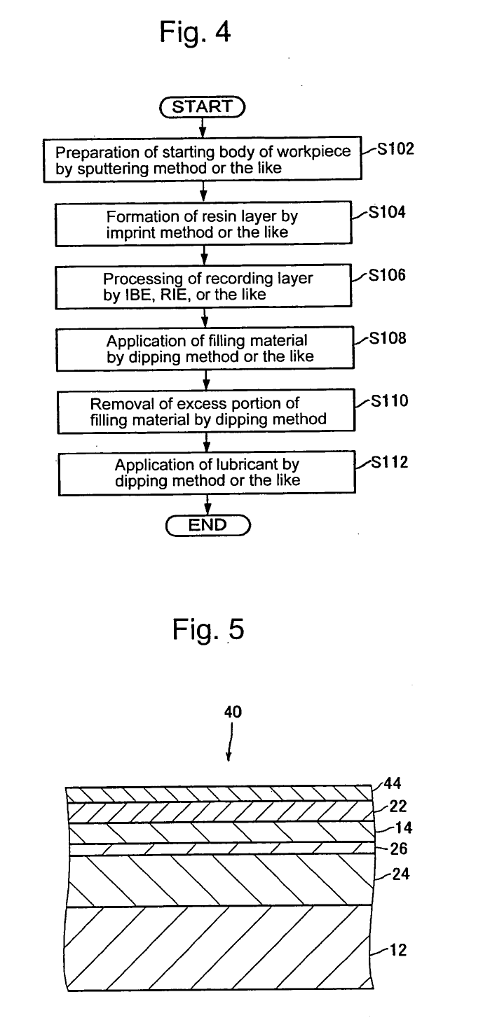

A description will now be given of a method for manufacturing the magnetic recording medium 10 with reference to the flowchart shown in FIG. 4.

First, a starting body of a workpiece 40 shown in FIG. 5 is prepared (S102). The starting body of the workpiece 40 can be obtained by depositing the soft magnetic layer 24, the seed layer 26, the recording layer 14 (being a continuous film before being processed into the concavo-convex pattern), the protection film 22 (being a continuous film before being processed into the concavo-convex pattern), and a mask layer 44 over the substrate 12. These layers are deposited in that order by a sputtering method, a CVD method, or other method. Ni, for example, may be used as the material for the mask layer 44. The protection film 22 is initially deposited to a thickness greater by, for example, about 1 to 2 nm than the final thickness on the recording elements 14A.

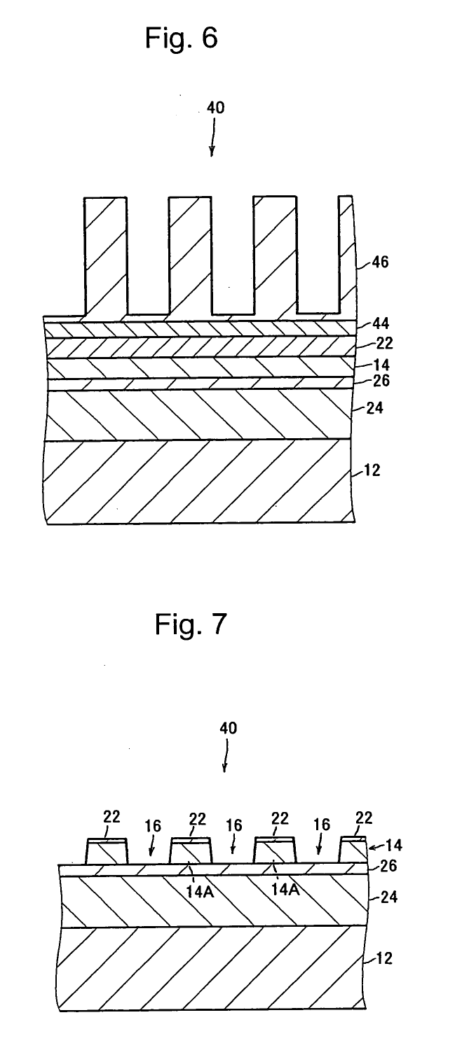

Next, as shown in FIG. 6, a resin material is applied to the mask layer 44 of the workpiece 40 using a spin coating method, and a concavo-convex pattern corresponding to the concavo-convex pattern of the recording layer 14 is transferred to the resin material by an imprint method using a stamper (not shown), whereby a resin layer 46 is formed to have the concavo-convex pattern (S104). Thermal imprinting, optical imprinting using, for example, UV light, or other method may be used as the imprint method. When thermal imprinting is used, a thermoplastic resin, for example, may be used as the material for the resin layer 46. When optical imprinting is used, a UV curable resin, for example, may be used as the material for the resin layer 46. The thickness of the resin layer 46 (the thickness of convex portions) is, for example, 10 to 300 nm. A photosensitive resist or an electron beam resist may be used as the resin material. In such a case, the resin layer 46 may be formed to have a concavo-convex pattern corresponding to the concavo-convex pattern of the recording layer 14 by optical lithography or electron beam lithography. The resin layer 46 remaining under the bottom portions of the concave portions is removed by, for example, ashing.

Next, the mask layer 44 under the bottom portions of the concave portions is removed by IBE (Ion Beam Etching) or RIE (Reactive Ion Etching) using an inert gas such as Ar gas, and the protection film 22 under the bottom portions of the concave portions is removed by IBE or RIE using O₂ gas. Then, the recording layer 14 under the bottom portions of the concave portions is removed by IBE or RIE using an inert gas such as Ar gas (S106). In this manner, the workpiece 40 is obtained which includes: the recording layer 14 having the concavo-convex pattern and divided into a large number of recording elements 14A; and the protection film 22 disposed on the upper surfaces of the recording elements 14A. In other words, the workpiece 40 having a surface formed in a predetermined concavo-convex pattern is obtained. The protection film 22 serves as a mask during etching for removing the recording layer 14 under the bottom portions of the concave portions. Therefore, the thickness of the protection film 22 disposed on the upper surfaces of the recording elements 14A is less than the initial deposition thickness of the continuous protection film 22.

In this application, the term “IBE” is used as a generic term for a processing method, such as ion milling, in which a workpiece is irradiated with an ionized gas to remove a target material. In this application, even when a gas, such as an inert gas, that is not chemically reactive with a target material is used, the term “RIE” is used when an RIE apparatus is used for etching.

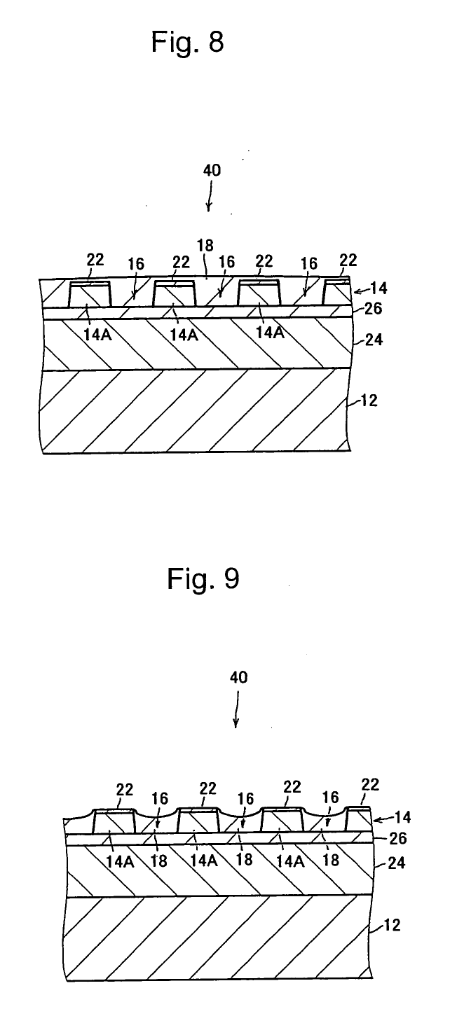

Next, as shown in FIG. 8, the filling material 18 is applied to the workpiece 40 with the surface formed in the concavo-convex pattern using a dipping method, a spin coating method, a spray coating method, or the like, whereby the filling material 18 is disposed in the concave portions 16 of the concavo-convex pattern (a filling material applying step: S108). Since the filling material 18 is a flowable fluorine-based organic compound, the application of the filling material 18 to the workpiece 40 having the concavo-convex pattern allows the filling material 18 to be easily disposed in the concave portions 16 of the concavo-convex pattern. Moreover, since the filling material 18 is a flowable fluorine-based organic compound, the upper surface of the filling material 18 is flatter than the upper surface of the workpiece 40 before the filling material 18 is applied thereto. The filling material 18 is applied not only to the concave portions 16 between the recording elements 14A but also to the protection film 22 on the recording elements 14A.

Next, as shown in FIG. 9, the workpiece 40 is immersed in a solvent using a dipping method, and the filling material 18 near the surface is dissolved to remove the excess portion of the filling material 18 (an excess filling material removing step: S110). For example, any of Fluorinert (Registered Trade Mark: fluorine-based inert liquid), alcohols (such as ethanol and isopropyl alcohol), acetone, and the like may be used as the solvent. The phrase “the excess portion of the filling material 18” is used to mean the filling material 18 present on the upper side (the side opposite to the substrate 12) of the upper surface of the protection film 22 on the recording elements 14A. In this manner, the filling material 18 (on the protection film 22) over the recording elements 14A is completely removed. By adjusting the time of immersing the workpiece 40 in the solvent, the upper surface portions of the filling material 18 disposed in the concave portions 16 can be formed into concave shapes having central portions lower than the peripheral portions in proximity to the recording elements 14A. In this case, the central portions of the upper surface portions of the filling material 18 disposed in the concave portions 16 (the lowest portions of the upper surface) are lower than the upper surface of the protection film 22 on the recording elements 14A. After the removal of the excess portion of the filling material 18, the solvent is removed by annealing treatment to dry the filling material 18.

Next, the lubricant 20 is applied to the filling material 18 disposed in the concave portions 16 and to the protection film 22 disposed on the recording elements 14A by a dipping method, a spin coating method, a spray coating method, or the like (a lubricant applying step: S112). Subsequently, the lubricant 20 is dried by annealing treatment. In this manner, the magnetic recording medium 10 shown in FIGS. 2 and 3 is completed.

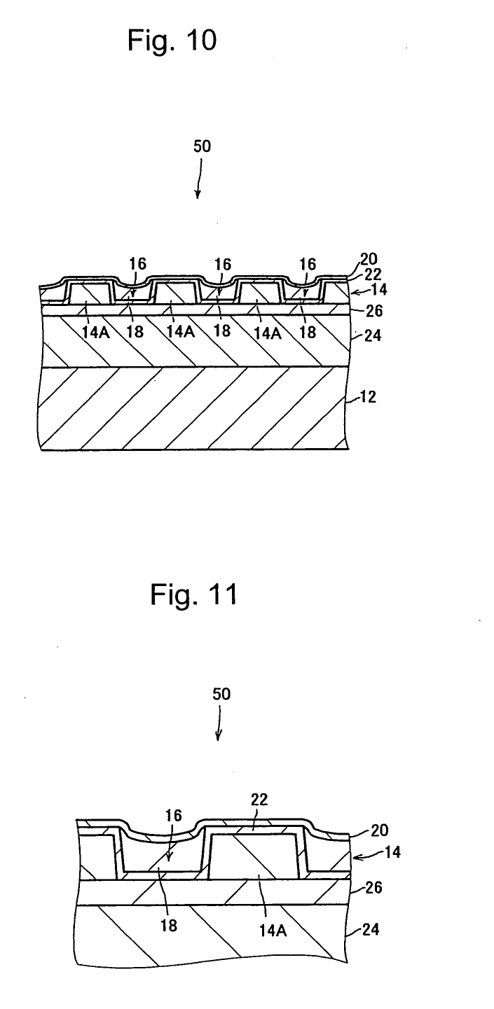

A description will now be given of a second exemplary embodiment of the present invention. As described above, in the magnetic recording medium 10 according to the first exemplary embodiment, the protection film 22 is disposed only on the upper surfaces of the recording elements 14A. However, in a magnetic recording medium 50 according to the second exemplary embodiment, the protection film 22 (a component composed of DLC) is disposed not only on the upper surfaces of the recording elements 14A but also on the side surfaces of the recording elements 14A and on the bottom surfaces of the concave portions 16 (in the concave portions 16), as shown in FIGS. 10 and 11. Since the configuration of the other components is the same as or similar to that of the magnetic recording medium 10 according to the first exemplary embodiment, the same numerals as those used in FIGS. 1 to 9 are used for the same or similar components, and the description thereof will be omitted.

The OH groups contained in the functional groups of the filling material 18 are easily bonded to DLC, which is the material for the protection film 22. Therefore, the bond between the protection film 22 disposed in the concave portions 16 and the filling material 18 disposed in the concave portions 16 can further suppress the flow of the filling material 18 disposed in the concave portions 16.

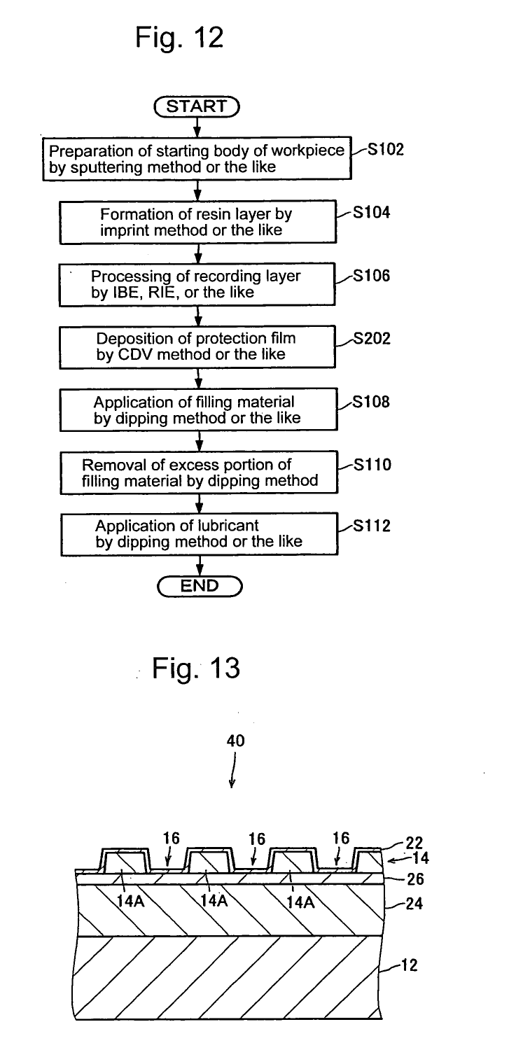

A description will now be given of a method for manufacturing the magnetic recording medium 50 with reference to the flowchart shown in FIG. 12.

As in the first exemplary embodiment, the starting body of workpiece preparing step (S102), the resin layer forming step (S104), and the recording layer processing step (S106) are performed. In this manner, the workpiece 40 shown in FIG. 7 is obtained which includes: the recording layer 14 formed in the concavo-convex pattern and divided into a large number of recording elements 14A; and the protection film 22 disposed on the upper surfaces of the recording elements 14A. In other words, the workpiece 40 having a surface formed in a predetermined concavo-convex pattern is obtained. In the starting body of workpiece preparing step (S102) in the second exemplary embodiment, the protection film 22 is deposited so as to have a thickness less than that in the first exemplary embodiment, so that the thickness of the protection film 22 remaining on the upper surfaces of the recording elements 14A after the recording layer processing step (S106) is less than that in the first exemplary embodiment. In the recording layer processing step (S106), the protection film 22 on the recording elements 14A may be completely removed. Alternatively, the protection film 22 on the recording elements 14A may be removed by dry etching using a gas such as a hydrogen-containing gas (for example, H₂ gas or NH₃ gas), O₂ gas, or O₃ gas after the recording layer processing step (S106).

Next, as shown in FIG. 13, an additional protection film 22 is deposited on the workpiece 40 by a CVD method or the like (S202). The resultant protection film 22 is disposed on the upper surfaces of the recording elements 14A, the side surfaces of the recording elements 14A, and the bottom surfaces of the concave portions 16 so as to conform to the concavo-convex pattern of the workpiece 40.

Subsequently, as in the first exemplary embodiment, the filling material applying step (S108), the excess filling material removing step (S110), and the lubricant applying step (S112) are performed. In this manner, the magnetic recording medium 50 shown in FIGS. 10 and 11 is completed.

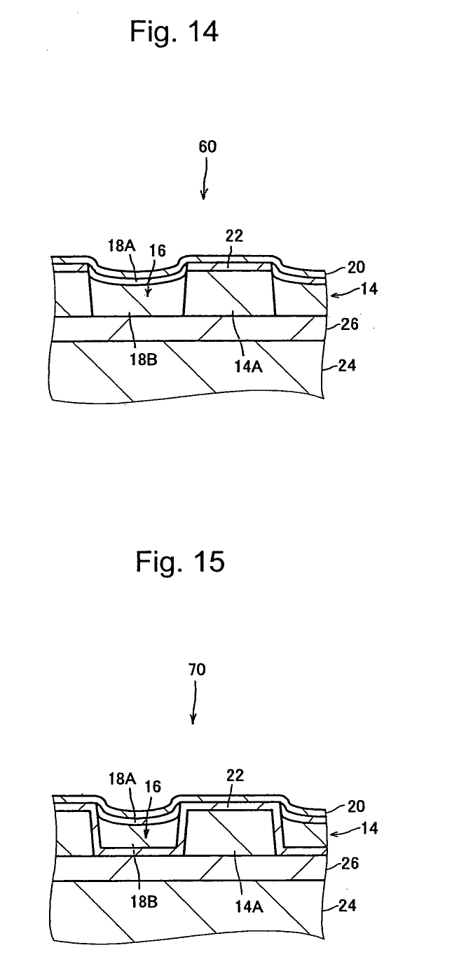

A description will now be given of a third exemplary embodiment of the present invention. In the magnetic recording medium 10 according to the first exemplary embodiment, only one type of the filling material 18 is disposed in the concave portions 16 between the recording elements 14A. However, in a magnetic recording medium 60 according to the third exemplary embodiment, a first filling material 18A and a second filling material 18B are disposed in the concave portions 16, as shown in FIG. 14. In other words, two types of filling materials are disposed in the concave portions 16. Since the configuration of the other components is the same as or similar to that of the magnetic recording medium 10 according to the first exemplary embodiment, the same numerals as those used in FIGS. 1 to 9 are used for the same or similar components, and the description thereof will be omitted.

As the filling material 18, the first filling material 18A and the second filling material 18B are fluorine-based organic compounds, and the mass average molecular weights of the first and second filling materials 18A and 18B are greater than the mass average molecular weight of the lubricant 20.

Also when two types of filling materials (the first and second filling materials 18A and 18B) are disposed in the concave portions 16, the flow of the filling materials from the concave portions 16 onto the recording elements 14A can be suppressed as in the first exemplary embodiment in which one type of the filling material 18 is disposed in the concave portions 16.

One or both of the first and second filling materials 18A and 18B may be thinner in thickness than the lubricant 20. However, preferably, the total thickness of the first and second filling materials 18A and 18B disposed in the concave portions 16 is greater than the thickness of the lubricant 20 disposed on these filling materials. Also when the total thickness of the filling materials disposed in the concave portions 16 is greater than the thickness of the lubricant 20 disposed on these filling materials, the thickness of the easily flowable lubricant 20 disposed in the concave portions can be small. Therefore, the flow of the lubricant 20 disposed in the concave portions 16 onto the recording elements 14A can be suppressed.

The magnetic recording medium 60 according to the third exemplary embodiment can be manufactured by repeating twice the filling material applying step (S108) and the excess filling material removing step (S110), in contrast to the first exemplary embodiment. The filling material applying step (S108) and the excess filling material removing step (S110) may be repeated three or more times to dispose three or more types of filling materials in the concave portions 16. In this case, some or all of the three or more types of filling materials may be thinner in thickness than the lubricant 20. However, preferably, the total thickness of the three or more types of filling materials disposed in the concave portions 16 is greater than the thickness of the lubricant 20 disposed on these filling materials.

A description will now be given of a fourth exemplary embodiment of the present invention. As shown in FIG. 15, a magnetic recording medium 70 according to the fourth exemplary embodiment is one configured such that the third exemplary embodiment is applied to the magnetic recording medium 50 according to the second exemplary embodiment. As in the third exemplary embodiment, the first filling material 18A and the second filling material 18B are disposed in the concave portions 16. Since the configuration of the other components is the same as or similar to those of the magnetic recording media 50 and 60 according to the second and third exemplary embodiments, the same numerals as those used in FIGS. 1 to 14 are used for the same or similar components, and the description thereof will be omitted.

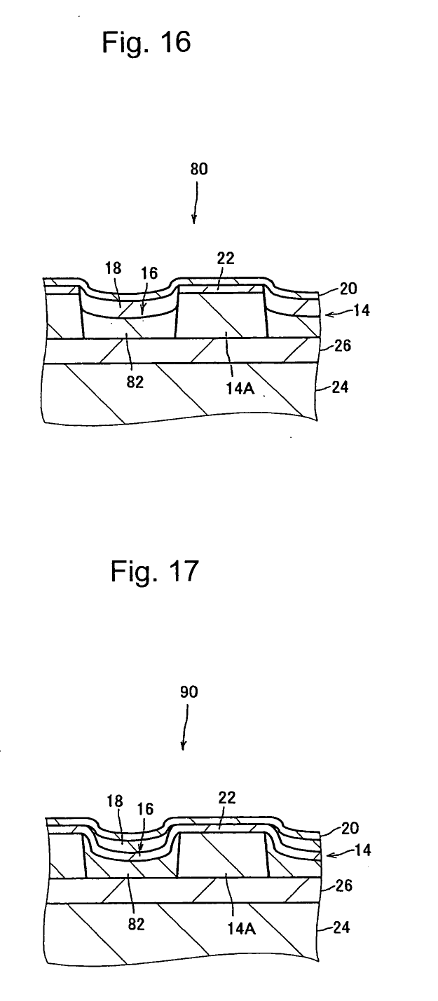

A description will now be given of a fifth exemplary embodiment of the present invention. In the magnetic recording medium 10 according to the first exemplary embodiment, the filling material 18 is disposed in contact with the bottom surfaces of the concave portions 16 between the recording elements 14A. However, in a magnetic recording medium 80 according to the fifth exemplary embodiment, a non-magnetic material 82 is disposed on the bottom surfaces of the concave portions 16, and the filling material 18 is disposed in contact with the non-magnetic material 82, as shown in FIG. 16. The non-magnetic material 82 is not a fluorine-based organic compound. The non-magnetic material 82 may be SiO₂, DLC, a non-magnetic metal material, or the like. Since the configuration of the other components is the same as or similar to that of the magnetic recording medium 10 according to the first exemplary embodiment, the same numerals as those used in FIGS. 1 to 9 are used for the same or similar components, and the description thereof will be omitted.

As described above, the mass average molecular weight of the filling material 18 is greater than that of the lubricant 20. Therefore, also in the case where the non-magnetic material 82 is disposed on the bottom surfaces of the concave portions 16 and the filling material 18 is disposed in contact with the non-magnetic material 82, the flow of the filling material 18 from the concave portions 16 onto the recording elements 14A can be suppressed as in the first exemplary embodiment in which the filling material 18 is disposed in contact with the bottom surfaces of the concave portions 16. To enhance the effect of suppressing the flow of the filling material 18 from the concave portions 16 onto the recording elements 14A, it is preferable that the non-magnetic material 82 be DLC or the like.

In contrast to the first exemplary embodiment, the non-magnetic material 82 is deposited by a sputtering method or a CVD method between the recording layer processing step (S106) and the filling material applying step (S108). Subsequently, the non-magnetic material 82 over the recording elements 14A is removed by dry etching or the like, and the surface of the workpiece is processed until the upper surface of the non-magnetic material 82 in the concave portions 16 is lower than the upper ends of the concave portions. Then, the filling material applying step (S108) is performed. In this manner, the magnetic recording medium 80 according to the fifth exemplary embodiment can be manufactured.

A description will now be given of a sixth exemplary embodiment of the present invention. A magnetic recording medium 90 according to the sixth exemplary embodiment is one configured such that the fifth exemplary embodiment is applied to the magnetic recording medium 50 according to the second exemplary embodiment, as shown in FIG. 17. As in the fifth exemplary embodiment, the non-magnetic material 82 is disposed on the bottom surfaces of the concave portions 16. In the concave portions 16, the protection film 22 is disposed on the non-magnetic material 82. The filling material 18 is disposed in contact with the upper surface of the protection film 22 in the concave portions 16. Since the configuration of the other components is the same as or similar to those of the magnetic recording media 50 and 80 according to the second and fifth exemplary embodiments, the same numerals as those used in FIGS. 1 to 16 are used for the same or similar components, and the description thereof will be omitted.

In contrast to the second exemplary embodiment, the non-magnetic material 82 is deposited by a sputtering method or a CVD method between the recording layer processing step (S106) and the protection film depositing step (S202). Subsequently, the non-magnetic material 82 on the recording elements 14A is removed by dry etching or the like, and the surface of the workpiece is processed until the upper surface of the non-magnetic material 82 in the concave portions 16 is lower than the upper ends of the concave portions. Then, the protection film depositing step (S202) and the filling material applying step (S108) are performed. In this manner, the magnetic recording medium 90 according to the sixth exemplary embodiment can be manufactured.

In the first to sixth exemplary embodiments, the filling material 18, the first filling material 18A, and the second filling material 18B are disposed only in the concave portions 16 between the recording elements 14A and not disposed over the recording elements 14A. However, the filling materials may be disposed over the recording elements. In such a case, it is preferable that the thickness of the filling materials be greater in the concave portions than over the recording elements. When a plurality of types of filling materials are deposited as in the third and fourth exemplary embodiments, it is preferable that the total thickness of the plurality of types of filling materials be greater in the concave portions than over the recording elements. When the total thickness of the filling materials disposed over the recording elements is less than the total thickness of the filling materials disposed in the concave portions between the recording elements, the magnetic gap between the recording elements and the magnetic head is small, so that good recording and reproducing characteristics are obtained.

In the first to sixth exemplary embodiments, DLC is shown as the example of material for the protection film 22. However, the material for the protection film 22 is not limited to DLC. For example, any of C (carbon, not DLC), non-magnetic metal materials such as Si, Ta, Ti, and W, oxides such as SiO₂ and Al₂O₃, nitrides such as Si₃N₄, AlN, TiN, and TaN, and carbides such as SiC and TiC may be used as the material for the protection layer.

In the first to sixth exemplary embodiments, the protection film 22 is disposed on the recording elements 14A. However, various exemplary embodiments of the invention are applicable to a magnetic recording medium not including a protection film.

In the first to sixth exemplary embodiments, the soft magnetic layer 24 and the seed layer 26 are formed below the recording layer 14. However, the configuration of the layers below the recording layer 14 may be appropriately changed according to the type of a magnetic recording medium. For example, an under layer and/or an antiferromagnetic layer may be formed between the soft magnetic layer 24 and the substrate 12. One or both of the soft magnetic layer 24 and the seed layer 26 may be omitted. The recording layer may be formed directly on the substrate.

In the first to sixth exemplary embodiments, the continuous protection film 22, the mask layer 44, and the resin layer 46 are formed over the continuous recording layer 14, and the recording layer 14 is formed into the concavo-convex pattern by three-step dry etching. However, so long as the recording layer 14 can be processed with high precision, the materials for the mask layer and the resin layer, the number of deposited layers, the thicknesses thereof, the type of dry etching, and other factors are not particularly limited.

In the magnetic recording media (10, 50, 60, 70, 80, and 90) of the first to sixth exemplary embodiments, the concave portions of the concavo-convex pattern of the recording layer are formed so as to reach the upper surface of the seed layer 26 which is in contact with the recording layer 14. However, various exemplary embodiments of the invention are applicable to a magnetic recording medium configured such that the concave portions of the concavo-convex pattern of the recording layer 14 are formed so as to reach some midpoint in the seed layer, the lower surface of the seed layer, or a layer on the substrate side of the seed layer (for example, the soft-magnetic layer).

In the first to sixth exemplary embodiments, the magnetic recording medium (10, 50, 60, 70, 80, or 90) is a single-sided medium in which the recording layer 14 and other layers are formed only on one side of the substrate. However, various exemplary embodiments of the invention are applicable to a double-sided magnetic recording medium in which the recording layer and other layers are formed on both sides of the substrate.

In the first to sixth exemplary embodiments, the magnetic recording medium (10, 50, 60, 70, 80, or 90) is a discrete track medium of the perpendicular recording type in which the recording layer 14 is divided in radial direction of tracks at small radial intervals. However, various exemplary embodiments of the invention are applicable to: patterned media in which the recording layer is divided at small intervals in both the radial and circumferential directions of tracks; magnetic disks including a spiral-shaped recording layer; magnetic disks including a recording layer that is formed separately on upper surfaces of convex portions and on bottom surfaces of concave portions of a concavo-convex pattern of a layer below the recording layer, wherein the portions formed on the upper surfaces of the convex portions serve as the recording elements; magnetic disks including a recording layer having concave portions that are formed to a certain depth in the thickness direction such that the recording layer is continuous in the bottom portion; and magnetic disks including a continuous recording layer formed in a concavo-convex pattern so as to conform to concavo-convex pattern of a layer below the recording layer. Various exemplary embodiments of the invention are also applicable to magnetic disks of a longitudinal recording type. Moreover, various exemplary embodiments of the invention are applicable to magneto-optical disks such as MO disks, magnetic disks of a heat assisted type in which magnetism and heat are used, and magnetic recording media, such as magnetic tapes, having a shape other than a disk shape and including a recording layer formed in a concavo-convex pattern.

### Working Example

Six types of samples W1 to W6 corresponding to the magnetic recording media 10, 50, 60, 70, 80, and 90 according to the first to sixth exemplary embodiments were produced. More specifically, the samples W1 to W6 are discrete track media of disk-like shape. The other main specifications of the samples W1 to W6 are shown in Table 2.

TABLE 2

| | Sample | | | | | | | |
|---|---|---|---|---|---|---|---|---|
| | W1 | W2 | W3 | W4 | W5 | W6 | C1 | C2 |
| Outer diameter (mm) | 48 | 65 | 95 | 95 | 65 | 95 | 65 | 65 |
| Nominal outer diameter (inch) | 1.8 | 2.5 | 3.5 | 3.5 | 2.5 | 3.5 | 2.5 | 2.5 |
| Rotation speed (rpm) | 3600 | 5400 | 7200 | 7200 | 5400 | 7200 | 5400 | 5400 |
| Track pitch (nm) | 70 | | | | | | | |
| Recording element width (nm) | 47 | | | | | | | |
| Concave portion width (nm) | 23 | | | | | | | |
| Protection layer thickness (nm) | 3 | | | | | | | |
| Recording layer thickness (nm) | 14 | | | | | | | |
| Concave portion depth (nm) | 18 | 21 | 18 | 30 | 18 | 21 | 18 | 18 |
| Lubricant thickness (nm) | 2 | 2 | 2 | 2 | 2 | 2 | 2 (12) | 2 (12) |
| Filling material thickness (nm) | 10 | 15 | — | — | 15 | 10 | — | — |
| First filling material thickness (nm) | — | — | 3 | 5 | — | — | — | — |
| Second filling material thickness (nm) | — | — | 11 | 18 | — | — | — | — |
| Non-magnetic material thickness (nm) | — | — | — | — | 10 | 5 | — | — |

The track pitch given in Table 2 is that in the data areas. The width of the recording elements given in Table 2 is the radial width of the recording elements 14A at the level of the upper surface of the recording layer 14 in the data areas. The width of the concave portions given in Table 2 is the radial width of the concave portions 16 at the level of the upper surface of the recording layer 14 in the data areas. The depth of the concave portions given in Table 2 is the distance in the thickness direction of the magnetic recording medium between the bottom surfaces of the concave portions and the upper surface of the protection film on the recording elements after completion of the processing of the recording layer. In each of the samples W1 to W6, the concave portions were formed so as to reach the seed layer, and adjacent recording elements were divided by the concave portions.

In each of the samples W1 to W6, the filling material 18, the first filling material 18A, and/or the second filling material 18B were/was disposed only in the concave portions 16 and not disposed over the recording elements 14A.

The lubricants 20 used in the samples W1 to W6, the filling materials 18 used in the samples W1, W2, W5, and W6, and the first and second filling materials 18A and 18B used in the samples W3 and W4 are listed in Tables 3 to 5.

TABLE 3

| Sample | | Lubricant | Filling material |
|---|---|---|---|
| W1 | Chemical formula | Formula (I) | Formula (I) |
| | | m ≈ 10 n ≈ 10 | m ≈ 10.3 n ≈ 10.3 |
| | | X: —CH₂—OH | X: —CH₂—O—CH₂—CH(OH)—CH₂—OH |
| | | Z: —CH₂—OH | Z: —CH₂—O—CH₂—CH(OH)—CH₂—OH |
| | Mass average | 2000 | 2165 |
| | molecular weight | | |
| W2 | Chemical formula | Formula (I) | Formula (I) |
| | | m ≈ 5.6 n ≈ 5.6 | m ≈ 3.7 n ≈ 3.7 |
| | | X: [Chemical formula 1] | X: [Chemical formula 1] |
| | | Z: —CH₂—OH | Z: [Chemical formula 1] |
| | Mass average | 2144 | 2740 |
| | molecular weight | | |

TABLE 4

| Sample | | Lubricant | First filling material | Second filling material |
|---|---|---|---|---|
| W3 | Chemical formula | Formula (I) | Formula (I) | Formula (I) |
| | | m ≈ 3.7 n ≈ 3.7 | m ≈ 10.3 n ≈ 10.3 | m ≈ 23.5 n ≈ 23.5 |
| | | X: [Chemical formula 1] | X: [Chemical formula 1] | X: [Chemical formula 1] |
| | | Z: [Chemical formula 1] | Z: [Chemical formula 1] | Z: [Chemical formula 1] |
| | Mass average | 2740 | 3954 | 6354 |
| | molecular weight | | | |
| W4 | Chemical formula | Formula (I) | Formula (I) | Formula (I) |
| | | m ≈ 3.7 n ≈ 3.7 | m ≈ 10.3 n ≈ 10.3 | m ≈ 23.5 n ≈ 23.5 |
| | | X: [Chemical formula 1] | X: [Chemical formula 1] | X: [Chemical formula 1] |
| | | Z: [Chemical formula 1] | Z: [Chemical formula 1] | Z: [Chemical formula 1] |
| | Mass average | 2740 | 3954 | 6354 |
| | molecular weight | | | |

TABLE 5

| Sample | | Lubricant | Filling material |
|---|---|---|---|
| W5 | Chemical formula | Formula (I) | Formula (I) |
| | | m ≈ 5.6 n ≈ 5.6 | m ≈ 3.7 n ≈ 3.7 |
| | | X: [Chemical formula 1] | X: [Chemical formula 1] |
| | | Z: —CH₂—OH | Z: [Chemical formula 1] |
| | Mass average molecular | 2144 | 2740 |
| | weight | | |
| W6 | Chemical formula | Formula (I) | Formula (I) |
| | | m ≈ 3.7 n ≈ 3.7 | m ≈ 36.9 n ≈ 36.9 |
| | | X: [Chemical formula 1] | X: [Chemical formula 1] |
| | | Z: [Chemical formula 1] | Z: [Chemical formula 1] |
| | Mass average molecular | 2740 | 8794 |
| | weight | | |

The lubricant used in W1 shown in Table 3 is Fomblin-Z-Dol-2000 (Solvay Solexis) described above. The filling material used in W1 shown in Table 3 is Fomblin-Z-TETRAOL-2000S (Solvay Solexis) described above. The lubricants used in W2 shown in Table 3 and used in W5 shown in Table 5 are MORESCO Phosfarol A20H (Matsumura Oil Research Corp.) described above. The filling materials used in W2 shown in Table 3 and used in W5 shown in Table 5 are MORESCO Phosfarol A20H-D (Matsumura Oil Research Corp.) described above. The lubricants used in W3 and W4 shown in Table 4 and used in W6 shown in Table 6 are also MORESCO Phosfarol A20H-D (Matsumura Oil Research Corp.) described above.

These samples W1 to W6 were loaded onto magnetic recording and reproducing apparatus. While each of the samples W1 to W6 was rotated, the seek motion of the magnetic head between the innermost track and the outermost track was repeated to test each sample. This test was continuously conducted for one month. The magnetic head was designed such that the flying height is 9 nm under atmospheric pressure. However, in this test, the pressure inside the magnetic recording and reproducing apparatus was held at about 800 hPa (lower than atmospheric pressure), and the average flying height of the magnetic head was set to 6 nm. More specifically, the test was performed under the conditions in which the contact between the magnetic head and the magnetic recording medium is more likely to occur than usual. During the test, the rear side of the magnetic head was irradiated with a laser beam, and the variations in the flying height of the head were observed utilizing a laser doppler effect. After completion of the test, the surfaces of the magnetic head and the magnetic recording medium were observed. No marks indicating contact with the magnetic head were found in all the samples W1 to W6.

Subsequently, the samples W1 to W6 were removed from the magnetic recording and reproducing apparatus and held under high-temperature and high-humidity conditions (temperature: 80° C., relative humidity: 80%) for 3 weeks, and then the surfaces of the samples W1 to W6 were observed. No corrosion was found in all the samples W1 to W6.

### Comparative Example

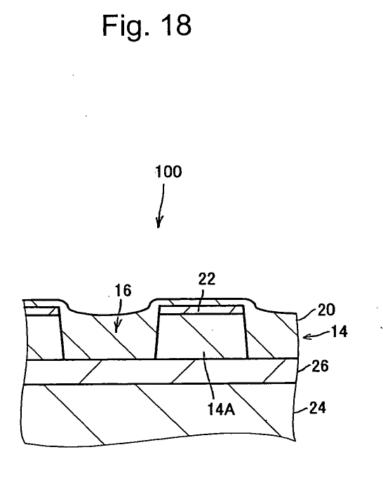

Two types of samples C1 and C2 of a magnetic recording medium 100 were produced. In contrast to sample W2 of the above Working Example, in these samples C1 and C2, the filling material 18 was not disposed in the concave portions 16, and the lubricant 20, instead of the filling material 18, was disposed in the concave portions 16, as shown in FIG. 18. MORESCO Phosfarol A20H (mass average molecular weight: 2144), which is the same as the lubricant used in the sample W2 shown in Table 3, was used as the lubricant 20 of the sample C1. The second filling material (mass average molecular weight: 6354) used in the samples W3 and W4 shown in Table 4 was used as the lubricant 20 of the sample C2. The thickness of the lubricants 20 used in C1 and C2 was 12 nm in the concave portions 16. As in Working Examples, the thickness of the lubricants 20 used in C1 and C2 was 2 nm over the recording elements 14A. The configuration of the other components of each of the samples C1 and C2 was the same as that of the sample W2. The main specifications of the samples C1 and C2 are also shown in Table 2.

As in Working Example, the seeking motion of the magnetic head between the innermost track and the outermost track was repeated continuously to test each of the samples C1 and C2. The test conditions were the same as those in Working Example.

For C2, abnormal variations (abnormally large variations) in the flying height of the head were observed on day 16, and therefore the test was terminated. The surfaces of the magnetic head and the magnetic recording medium were observed, and crash marks indicating contact between the magnetic head and the magnetic recording medium were found. The thickness of the lubricant 20 over the recording elements 14A was reduced to 0.5 to 1 nm (which is smaller by 1 to 2 nm than the thickness of the lubricant before the test) in many areas on the surface of the magnetic recording medium.

Also for C1, abnormal variations (abnormally large variations) in the flying height of the head were observed on day 25, and therefore the test was terminated. The surfaces of the magnetic head and the magnetic recording medium were observed, and crash marks indicating contact between the magnetic head and the magnetic recording medium were found, as in C2. The thickness of the lubricant 20 over the recording elements 14A was 4 to 5 nm. More specifically, the thickness of the lubricant 20 over the recording elements 14A was greater by 2 to 3 nm than that before the test.

After the crash marks indicating contact between the magnetic head and the magnetic recording medium were observed, each of the samples C1 and C2 (only the magnetic recording media) was held under high-temperature and high-humidity conditions (temperature: 80° C., relative humidity: 80%) for 3 weeks, and the surface of each sample was observed. No corrosion was found in the samples C1 and C2.

In the sample C1 of Comparative Example, the increase in the thickness of the lubricant over the recording elements may be caused by the flow of the lubricant disposed in the concave portions onto the recording elements during the high-speed rotation of the magnetic recording medium. Accordingly, the step height between convex portions and concave portions in the surface of the magnetic recording medium increased, and the flying height of the magnetic head became unstable. This may be the cause of the contact between the magnetic head and the magnetic recording medium.

In the sample C2, the mass average molecular weight of the lubricant was large, so that the shape of the lubricant deformed due to the intermittent contact with the magnetic head may not be fully restored. Therefore, the local irregularities(convex and concave portions) of the lubricant may cause the contact between the magnetic head and the magnetic recording medium.

However, no contact with the magnetic head was found in all the samples W1 to W6 of Working Example. As well as the lubricants 20, the filling materials 18 used in the samples W1, W2, W5, and W6 and the first and second filling materials 18A and 18B used in the samples W3 and W4 are flowable fluorine-based organic compounds. However, the mass average molecular weights of these filling materials are greater than those of the lubricants 20, so that these filling materials are less likely to flow than the lubricants 20. This may prevent the flow of the filling material 18 or the first and second filling materials 18A and 18B disposed in the concave portions 16 onto the recording elements 14A even when the samples W1 to W6 are rotated at a high-speed for a long period of time, and therefore the filling materials were held in the concave portions 16.

The flowability of the filling material 18 and the first and second filling materials 18A and 18B is lower than the flowability of the lubricants 20. Therefore, even if the filling material 18 or the first and second filling materials 18A and 18B disposed in the concave portions 16 flew onto the recording elements 14A, the filling material 18 or the first and second filling materials 18A and 18B might not flow onto the recording elements 14A to the extent that the magnetic head is likely to adhere to the magnetic recording medium, or the flying height of the magnetic head is unstable.

The lubricant 20 having a mass average molecular weight less than that of the filling material 18 (the first and second filling materials 18A and 18B) and capable of easily restoring its shape was disposed over the recording elements 14A and the filling material 18 (the first and second filling materials 18A and 18B). This might cause good lubrication of the surface of the magnetic recording medium 10.

As well as the lubricants 20, the filling material 18 and the first and second filling materials 18A and 18B were fluorine-based organic compounds that can serve as a lubricant over the recording elements 14A. Therefore, even if the filling material 18 or the first and second filling materials 18A and 18B disposed in the concave portions 16 flew onto the recording elements 14A, the lubrication of the surface of the magnetic recording medium might be maintained.

As described above, when the filling material disposed in the concave portions between the recording elements is a fluorine-based compound having a mass average molecular weight greater than that of the lubricant, a magnetic recording medium having good recording and reproducing characteristics and excellent in productivity can be obtained.

The present invention is applicable to a magnetic recording medium, such as a discrete track medium or a patterned medium, including a recording layer formed in a concavo-convex pattern.

What is claimed is:

1. A magnetic recording medium, comprising: a substrate;
a recording layer formed in a predetermined concavo-convex pattern over the substrate, the recording layer including recording elements formed as convex portions of the concavo-convex pattern;
a filling material disposed in a concave portion between the recording elements; and
a lubricant disposed over the recording element and the filling material,
wherein the filling material and the lubricant are fluorine-based organic compounds, and wherein a mass average molecular weight of the filling material is greater than a mass average molecular weight of the lubricant.

2. The magnetic recording medium according to claim 1, wherein
a thickness of the filling material is greater in the concave portion between the recording elements than over the recording element.

3. The magnetic recording medium according to claim 1, wherein
a thickness of the filling material disposed in the concave portion between the recording elements is greater than a thickness of the lubricant disposed over the filling material.

4. The magnetic recording medium according to claim 2, wherein
a thickness of the filling material disposed in the concave portion between the recording elements is greater than a thickness of the lubricant disposed over the filling material.

5. The magnetic recording medium according to claim 1, further comprising a protection film disposed on an upper surface of the recording element, and
wherein a lowest point of an upper surface of the filling material disposed in the concave portion between the recording elements is lower than an upper surface of the protection film on the recording element.

6. The magnetic recording medium according to claim 2, further comprising a protection film disposed on an upper surface of the recording element, and
wherein a lowest point of an upper surface of the filling material disposed in the concave portion between the recording elements is lower than an upper surface of the protection film on the recording element.

7. The magnetic recording medium according to claim 3, further comprising a protection film disposed on an upper surface of the recording element, and
wherein a lowest point of an upper surface of the filling material disposed in the concave portion between the recording elements is lower than an upper surface of the protection film on the recording element.

8. The magnetic recording medium according to claim 1, further comprising a component composed of DLC, the component being disposed in the concave portion between the recording elements, and
wherein the filling material is disposed in the concave portion so as to come into contact with the component composed of DLC.

9. The magnetic recording medium according to claim 2, further comprising a component composed of DLC, the component being disposed in the concave portion between the recording elements, and
wherein the filling material is disposed in the concave portion so as to come into contact with the component composed of DLC.

10. The magnetic recording medium according to claim 3, further comprising a component composed of DLC, the component being disposed in the concave portion between the recording elements, and
wherein the filling material is disposed in the concave portion so as to come into contact with the component composed of DLC.

11. The magnetic recording medium according to claim 5, further comprising a component composed of DLC, the component being disposed in the concave portion between the recording elements, and
wherein the filling material is disposed in the concave portion so as to come into contact with the component composed of DLC.

12. A magnetic recording and reproducing apparatus, comprising:
a magnetic recording medium according to claim 1; and
a magnetic head for recording and reproducing a magnetic signal on and from the magnetic recording medium.

13. A magnetic recording and reproducing apparatus, comprising:
a magnetic recording medium according to claim 2; and
a magnetic head for recording and reproducing a magnetic signal on and from the magnetic recording medium.

14. A magnetic recording and reproducing apparatus, comprising:
a magnetic recording medium according to claim 3; and
a magnetic head for recording and reproducing a magnetic signal on and from the magnetic recording medium.

15. A magnetic recording and reproducing apparatus, comprising:
a magnetic recording medium according to claim 5; and
a magnetic head for recording and reproducing a magnetic signal on and from the magnetic recording medium.

16. A magnetic recording and reproducing apparatus, comprising:
a magnetic recording medium according to claim 8; and
a magnetic head for recording and reproducing a magnetic signal on and from the magnetic recording medium.

17. A method for manufacturing a magnetic recording medium, comprising:
a filling material applying step of applying a filling material onto a workpiece having a surface formed in a predetermined concavo-convex pattern to thereby dispose the filling material in a concave portion of the concavo-convex pattern; and
a lubricant applying step of applying a lubricant onto the filling material,
wherein the filling material and the lubricant are fluorine-based organic compounds, and wherein a mass average molecular weight of the filling material is greater than a mass average molecular weight of the lubricant.
